(19) United States
(12) Patent Application Publication
(10) Pub. No.: US 2008/0219431 A1
(43) Pub. Date: Sep. 11, 2008

(54) METHOD AND APPARATUS FOR ECHO CANCELLATION

(75) Inventors: Qing-Guang Liu, Sunnyvale, CA (US); Wilson Or, Belmont, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignees: FORTEMEDIA, INC., Cupertino, CA (US); MAXSONICS, INC., Santa Clara, CA (US)

(21) Appl. No.: 12/044,070

(22) Filed: Mar. 7, 2008

Related U.S. Application Data
(60) Provisional application No. 60/905,955, filed on Mar. 9, 2007.

(51) Int. Cl. H04M 9/08; H04B 3/20

(52) U.S. Cl. 379/406.01; 379/406.06; 381/66

(57) ABSTRACT

A telephony system equipped with an echo cancellation module is disclosed. A hybrid interface circuit outputs an outbound signal to a wall jack while receiving an inbound signal from the wall jack. The inbound signal may contain a line echo of the outbound signal caused by the impedance mismatches in the hybrid interface circuit. A line echo canceller containing an adaptive filter is used to cancel the line echo in the inbound signal based on the learned line echo path characteristics captured in the training period. During a brief period after the telephony system is activated, the line echo canceller enters into a calibration mode wherein its adaptive filter is trained to learn the line echo path characteristics. During the calibration mode, the line echo canceller generates a calibration signal as the outbound signal and receives the line echo from the hybrid interface circuit to perform learning of the line echo path characteristics.

### CROSS REFERENCE TO RELATED APPLICATIONS

This application claims the benefit of U.S. Provisional Application No. 60/905,955, filed 2007, Mar. 9.

### BACKGROUND OF THE INVENTION

1. Field of the Invention

The invention relates to echo cancellation, and in particular, to a calibration method to acquire an echo path characteristics for echo cancellation.

2. Description of the Related Art

FIG. 1 shows a telephony system 100 equipped with an echo cancellation module for hands-free applications. The telephony system 100 may be a speakerphone attached to a wall jack 106 through a hybrid interface circuit 130. Due to impedance mismatch in the 2-wire to 4-wire circuitry, the hybrid interface circuit 130 may cause electrical signal reflections known as line echoes and it couples the line echo of the outbound electrical signal #Rₒᵤₜ into the inbound electrical signal #Rᵢₙ. The line echo may reduce the stability margin, also known as howling margin, of the telephony system 100 and jeopardize the hands-free telephone operations. Meanwhile, the telephony system 100 comprises a microphone 102 for receiving a local input signal #Lᵢₙ and a loudspeaker 104 outputting a local output signal #Lₒᵤₜ. The microphone 102 and loudspeaker 104 may constitute another coupling path that feeds back the acoustic echo of the local output signal #Lₒᵤₜ into the microphone 102. This acoustic echo may reduce the howling margin of the telephony system 100 and jeopardize the hands-free telephone operations. The two feed back loops in conjunction may form an infinite amplification loop resulting in an unstable system, causing a loud feedback noise known as howling that degrades or jeopardizes the telephone operation. To avoid the howling, an echo cancellation module 170 is provided as a prior art. The echo cancellation module 170 may be a digital signal processor comprising an acoustic echo canceller 150 and a line echo canceller 160 working in conjunction to stabilize the feed back loop to allow full-duplex conversations. The acoustic echo canceller 150 eliminates the acoustic echo of the local output signal #Lₒᵤₜ coupled into the local input signal #Lᵢₙ to generate an acoustic echo canceled signal #AC, and the line echo canceller 160 eliminates the electrical echo of the outbound signal #Rₒᵤₜ coupled into the inbound signal #Rᵢₙ to generate a line echo cancelled signal #LC.

The acoustic echo canceller 150 and line echo canceller 160 can be represented by adaptive filters, in which the filter coefficients are recursively updated using training procedures to learn echo path characteristics or the impulse response of the feedback path. When the echo path characteristics have been learned and therefore modeled adequately by the filter impulse response defined by the filter's coefficients, then the filter is converged. Otherwise, when the echo path characteristics have not been sufficiently learned by the filter coefficients, the filter impulse response will not match up with the impulse response of the echo path and the filter is then diverged. When the adaptive filter is converged, its coefficients approximate the echo path characteristics adequately and the echo can be effectively cancelled. When the adaptive filter is diverged, echo cancellation will not be achieved due to mismatch between the filter coefficients and the echo path characteristics. For a set of filter coefficients in diverged state, it takes a certain length of time for the training procedure to achieve convergence.

It is critical for the system to enter into stability rapidly and then maintain system stability so that system processing activities can continue and howling margin continue to improve. Generally, acoustic echo is much stronger than the line echo because the loudspeaker 104 usually requires a high gain output for hands-free speakerphone operation; it also have a longer tail-span in time due to the acoustics reflection of the ambient surfaces. The acoustic echo path couples the feedback signal through air, its characteristics may often undergo variations during a conversation due to objects moving in the acoustic echo path. Given these general characteristics of the acoustic echo path, the acoustic echo canceller 150 requires a longer filter length and therefore needs longer convergence time to adapt its filter coefficients. On the other hand, commercial line hybrid interface circuits generally have a non-positive gain in their echo path, the line echoes are generally not as strong and have a relatively short electrical echo tail span in time. The line echo path characteristics, which are determined by a particular hybrid interface circuitry and the phone line it is coupled to, do not undergo constant variations during a conversation. Therefore the line echo canceller 160 requires a shorter filter length and the adaptive filter can converge faster. During practical use, it is important to have either the acoustic echo canceller 150 or the line echo canceller 160 to converge first so that the system can be stabilized for further procedure. Because the line echo canceller generally converges faster, it is desirable to implement a rapid converging line echo canceller 160 to have it contribute to system stability rapidly, and then the acoustic echo canceller can continue to converge to improve on system stability. To have a rapidly converging line echo canceller 160, the method to reliably and quickly acquire the line echo path characteristics in the presence of interference signal is of prime importance.

### BRIEF SUMMARY OF THE INVENTION

An exemplary embodiment of a telephony system is disclosed. A hybrid interface circuit outputs an outbound signal to a wall jack while receiving an inbound signal from the wall jack. The inbound electrical signal may contain a line echo caused by the outbound electrical signal reflected by the hybrid interface circuitry. A line echo canceller performs a training procedure to learn the line echo path characteristics and then use it to cancel the line echo in the inbound signal. During a brief period immediately after the telephony system has been activated, the line echo canceller enters a calibration mode to learn the line echo path characteristics. During the calibration mode, the line echo canceller generates a calibration signal as the outbound signal and uses the received line echo from the hybrid interface circuit to perform its adaptive filter training to learn the line echo path characteristics.

The telephony system enters a normal mode when the brief calibration period is over, or when the user presses on a key in the telephone dial pad for digit dialing.

In an embodiment, the line echo canceller comprises a calibration signal generator, providing the calibration signal to the hybrid interface circuit when in the calibration mode, such that the line echo canceller can be trained rapidly in the presence of the interfering inbound dial-tone signal. The interfering dial-tone signal can inhibit or impede the filter training process. A first notch filter eliminates the dial-tone frequencies from the calibration signal to generate a first notched signal. An adaptive filter applies the filter coefficients on the first notched signal to produce a filter output, whereby coefficients in the adaptive filter are recursively updated using training procedures to learn the echo path characteristics. A second notch filter eliminates dial tone frequencies from the microphone inbound signal to generate a second notched signal. A subtractor subtracts the second notched signal by the filter output to generate the difference signal. The line echo canceller may further comprise a mute controller, enabled when in the calibration mode to prevent the difference signal from being output to the loudspeaker and the local listener.

When in the normal mode, the calibration signal generator, mute controller, first notch filter and second notch filter are disabled, and a normal outbound signal is output to the loudspeaker. The adaptive filter uses the learned echo path characteristics to generate a filter output from the normal outbound signal, and the subtractor subtracts the inbound signal by the filter output to generate a difference signal, whereby the difference signal is output as a line echo cancelled signal.

In an alternative embodiment, the line echo canceller comprises a first analysis filter bank, a second analysis filter bank and a plurality of filter units. The first analysis filter bank separates the outbound signal into a plurality of first frequency subband signals each corresponding to a subband, and the second analysis filter bank separates the inbound signal into a plurality of second frequency subband signals respectively. The plurality of filter units individually performs echo cancellations on each pair of first and second subband signals. Additionally, a synthesis filter bank synthesizes echo cancellation results output from the filter units to output a line echo cancelled signal. As described, a mute controller is enabled during the calibration mode to prevent the line echo cancelled signal from being output to a loudspeaker and the local listener.

One or more of the filter units corresponds to the frequency subband containing the dial tone frequencies, and those filter units are disabled during calibration mode and enabled only in the normal mode. When in calibration mode, the adaptive filter in each of the activated filter units learn the echo path characteristics corresponded to the frequency subband it is in. The dial tones localized in the disabled frequency subbands cannot inhibit or impede the training process in the other activated filter frequency subbands. When in the normal mode, the calibration signal generator and mute controller are disabled, and normal outbound signals become outputs. The filter units use the learned echo path characteristics to perform echo cancellation, and the synthesis filter bank outputs the recombined line echo cancelled signal to the loudspeaker.

The telephony system further comprises a loudspeaker, outputting a local output signal while a microphone is receiving a local input signal. An acoustic echo canceller cancels the acoustic echo of the local output signal from the local input signal to generate an acoustic echo canceled signal. The local output signal is the line echo cancelled signal output from the line echo canceller, and the acoustic echo canceled signal is sent to the line echo canceller and output as the outbound signal. In practice, the calibration signal is preferably a white noise signal. Additionally, an echo cancellation method implemented by the described telephony system is disclosed. A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional telephony system 100 with an echo cancellation module;

FIG. 2 is a flowchart of a calibration procedure according to the invention;

FIG. 3 shows an embodiment of a line echo canceller 300; and

FIG. 4 shows an alternative embodiment of a line echo canceller 400.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

A line echo canceller 160 usually requires training for at least several-hundred milliseconds to reach a satisfactory state where the strength of echo is reduced to a required level. The training time may be up to one or more seconds. In ITU-T Standard Recommendation G.168 “Digital Network Cancellers”, the criterion is specified as 20 dB echo reductions per second. Conventionally, the training procedure in the line echo canceller 160 is performed in the normal mode, whereby the local input signal #Lᵢₙ is received from the microphone 102 to be the outbound signal #Rₒᵤₜ towards the hybrid interface circuitry 130, while the inbound signal #Rᵢₙ is played by the loudspeaker 104 as the local output signal #L Lₒᵤₜ received by the hybrid interface circuitry 130. In the embodiment, a calibration method is described, in which the line echo canceller 160 is trained by an autonomously generated calibration signal immediately after telephone activation, because the calibration signal is specifically optimized for the line echo canceller 160, the required convergence time can be effectively minimized and the system stabilized quickly. Additionally, a mute mechanism is implemented to prevent any unpleasant audible signal from being output through the loudspeaker 104 while the calibration is in process.

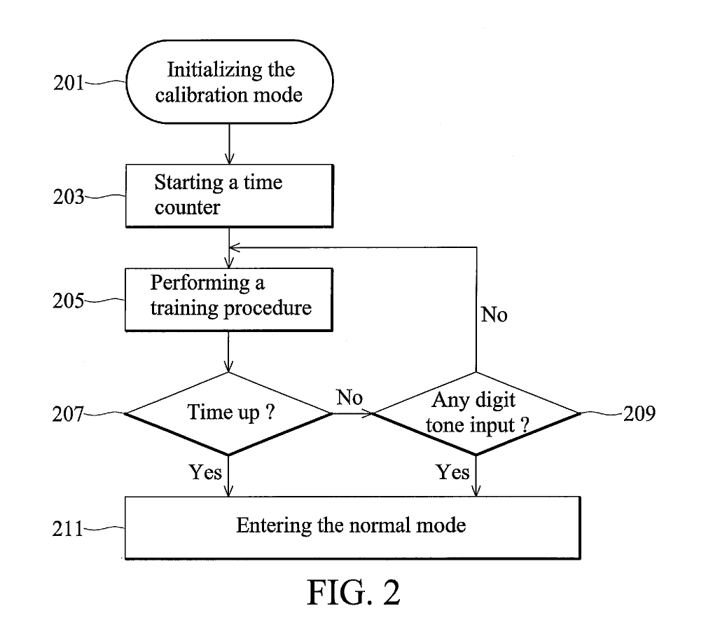

FIG. 2 is a flowchart of the training procedure according to the invention. In step 201, the telephony system 100 is activated when the local caller initiates a call and the telephone is taken from an on-hook state into an off-hook state. The telephony system 100 enters a calibration mode for a brief period immediately after the activation. In step 203, a timer is initiated to count the elapsed time for calibration. In step 205, the line echo canceller 300 generates a calibration signal as outbound signal #Rₒᵤₜ, and receives a line echo corresponding to the calibration signal that can be used to train the line echo canceller to obtain the echo path characteristics. In step 207, while step 205 is in process, the timer is checked for whether the brief time period defined for training is over. If not, the calibration continues, otherwise the line echo canceller 300 enters normal mode in step 211. During calibration, any entry of dialing digits by the local phone user will interrupt the calibration and initiate the normal mode operation. In step 209, it is checked whether any digit tone has been entered. If a digit tone has been entered, the line echo canceller 300 stops the calibration and enters the normal mode in step 211. In other words, the telephony system 100 enters into the normal mode whenever the brief time period for training is over or a digit tone is entered by the caller In step 211, a normal conversation call is initiated. The telephony system 100 outputs a normal outbound signal #Rₒᵤₜ to the wall jack 106 while receiving an inbound signal #Rᵢₙ from the wall jack 106, and the line echo canceller 300 performs an echo cancellation procedure using the learned echo path characteristics to cancel the line echo in the inbound signal #Rᵢₙ.

In the embodiment, the brief period may be 1 second or 2 seconds immediate after the local caller initiating a telephone call by taking the telephone off hook. Normal use will not be influenced by the brief period calibration unless someone enters a digit tone faster than 1 second following hook release. During the brief period, the training procedure of the line echo canceller learns the echo path characteristics so the line echo canceller 300 can be fully functional for normal use.

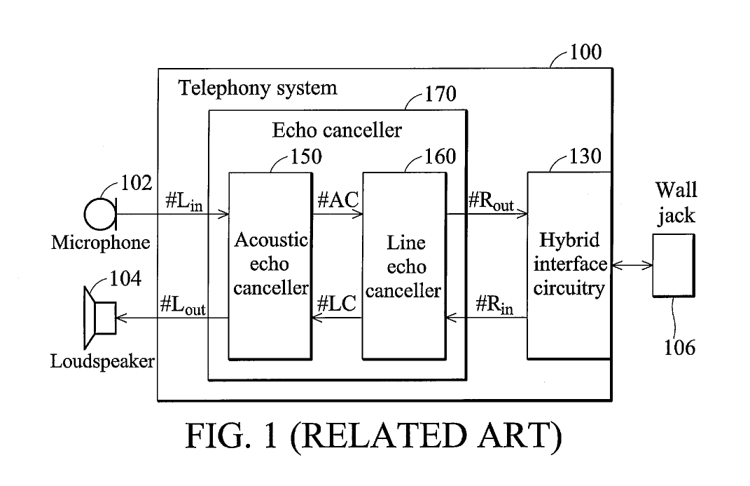

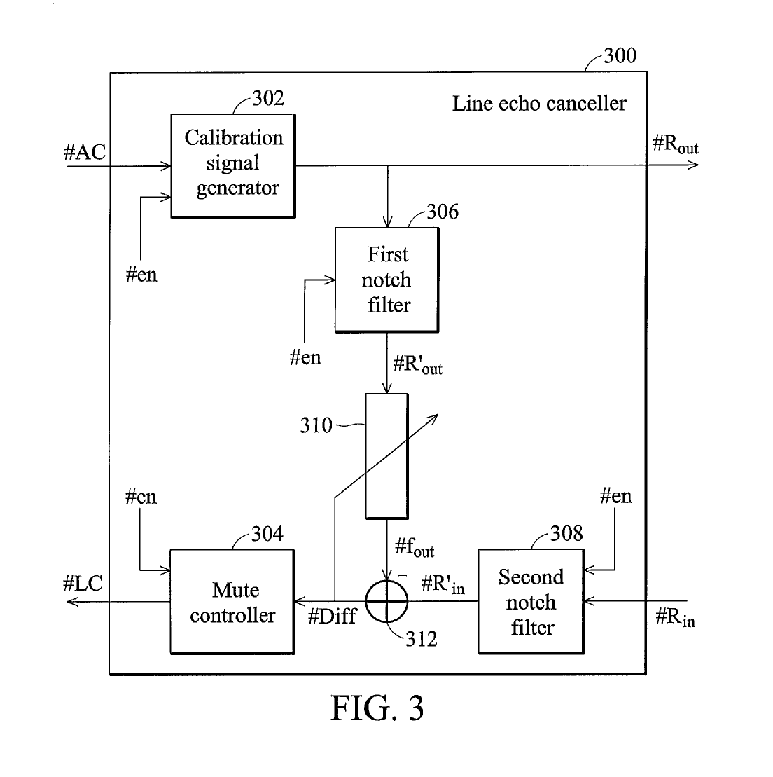

FIG. 3 shows an embodiment of a line echo canceller 300. In the embodiment, the line echo canceller 300 is implemented to substitute for the line echo canceller 160 in the FIG. 1. In addition to an adaptive filter 310 and a subtractor 312, extra components such as a calibration signal generator 302, a mute controller 304, a first notch filter 306 and a second notch filter 308 are added to the line echo canceller 300. When the calibration mode is started, the calibration signal generator 302 generates a calibration signal as the outbound signal #Rₒᵤₜ, and the second notch filter 308 receives an inbound signal #Rᵢₙ which contains the line echo of the outbound signal #Rₒᵤₜ returned by the hybrid interface circuitry 130. Since the telephone has been activated and therefore the telephone hook has been released, a dial tone from the telephone central office is input via the wall jack 106 in the inbound signal #Rᵢₙ. The dial tone frequencies are unwanted interference signals that interfere with the echo canceller training, the dial-tone signal can inhibit or impede the adaptive filter training process. The second notch filter 308 filters out the dial tone frequencies from the inbound signal #Rᵢₙ to generate a second notched signal #Rᵢₙ. Likewise, the first notch filter 306 filters out the dial tone frequencies from the calibration signal to generate a first notched signal #Rₒᵤₜ.

Generally, the first notch filter 306 and the second notch filter 308 can be implemented using bi-quadratic IIR filters. According to North American telephony standard, the dial tone in North America is a dual frequency signal comprising of pure tones of 350 Hz and 440 Hz. Corresponding filter coefficients can be calculated using standard digital signal processing filter design procedures to implement the first notch filter 306 and second notch filter 308, thus detailed description is omitted herein.

In this way, the adaptive filter 310 applies its filter coefficients on the first notched signal #R′ₒᵤₜ to generate a filter output #fₒᵤₜ, wherein the difference signal #Diff is a subtraction result from a subtractor 312 between the second notched signal #R′ᵢₙ and the filter output #fₒᵤₜ. As known, the adaptive filter 310 may be a Finite Impulse Response (FIR) filter, it applies filtering on input signal using convolution operation to generate output signal, and its coefficients are recursively updated using training procedures such as a Normalized Least Mean Square (NLMS) algorithm to learn the echo path characteristics. Both the filtering and filter coefficient update are standard digital signal processing procedures, thus detailed description is omitted herein.

In the normal mode, the difference signal #Diff is output as the line echo cancelled signal #LC. During the calibration period, however, the difference signal #Diff is not meant to be output because it contains no meaningful signal to the telephone user. In the embodiment, a mute controller 304 is enabled in the calibration mode to prevent the difference signal #Diff from being output to a loudspeaker 104 as unpleasant audible signals.

When the calibration is completed, the telephony system 100 enters into the normal mode. In the normal mode, the calibration signal generator 302, mute controller 304, first notch filter 306 and second notch filter 308 are disabled, and an acoustic echo canceled signal #AC sent from the acoustic echo canceller 150 is output to the hybrid interface circuit 130 as the outbound signal #Rₒᵤₜ. The echo path characteristics acquired in the calibration mode is used by the adaptive filter 310 as filter coefficients to apply on #Rₒᵤₜ and generate a filter output #fₒᵤₜ. The inbound signal #Rᵢₙ is directly passed to the subtractor 312, whereby the difference signal #Diff is generated by subtracting the filter output #fₒᵤₜ from the inbound signal #Rᵢₙ. Since the mute controller 304 is disabled, the difference signal #Diff is output as the line echo cancelled signal #LC.

As a supplemental description, another part of the telephony system 100 related to the hands-free telephone operation is described. As shown in FIG. 1, a loudspeaker 104 outputs a local output signal #Lₒᵤₜ while a microphone 102 receives a local input signal #Lᵢₙ and consequently, the local input signal #Lᵢₙ contains echo of the local output signal #Lₒᵤₜ and any local talker signal. An acoustic echo canceller 150 cancels the acoustic echo of the local output signal #Lₒᵤₜ from the local input signal #Lᵢₙ to generate an acoustic echo cancelled signal #AC. The line echo cancelled signal #LC output from the line echo canceller 300 is directly passed to be the local output signal #Lₒᵤₜ, and the acoustic echo canceled signal #AC output from the acoustic echo canceller 150 is taken as the outbound signal #Rₒᵤₜ in the normal mode.

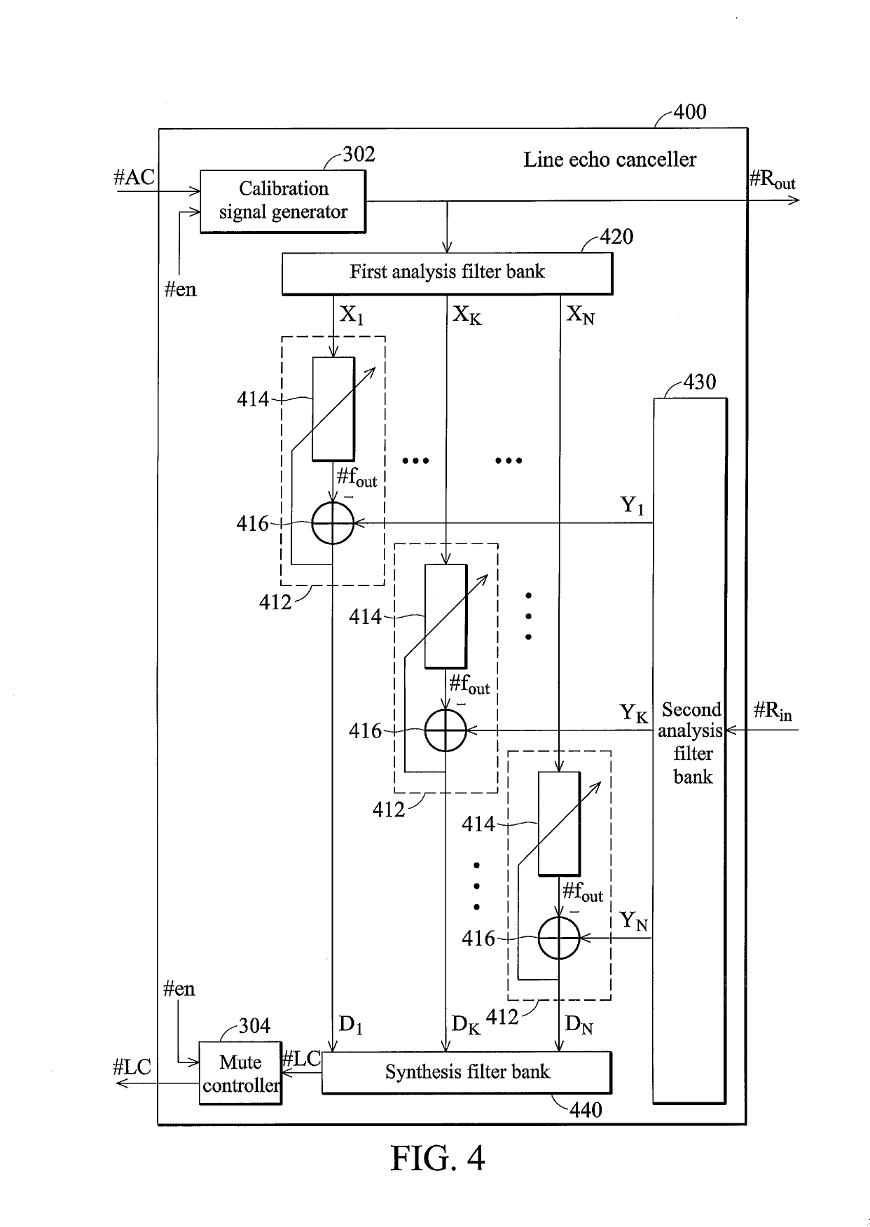

The line echo canceller 160 can be modified in an alternative way. FIG. 4 shows an alternative embodiment of a line echo canceller 400. Like the line echo canceller 300 in FIG. 3, a calibration signal generator 302 provides the calibration signal as the outbound signal #Rₒᵤₜ to the hybrid interface circuit 130 during the calibration mode. The echo cancellation in FIG. 4 is performed in frequency subbands. A first analysis filter bank 420 separates the outbound signal #Rₒᵤₜ into a plurality of first subband signals X_{K} (K=1 to N) each corresponding to a subband, and a second analysis filter bank 430 separates the inbound signal #Rᵢₙ into a plurality of second subband signals Y_{K} (K=1 to N) each corresponding to a subband. Each pair of first and second subband signals are individually processed by a plurality of filter units 412, and the set of subband results D_{K} (K=1 to N) output from the filter units 412 are input to a synthesis filter bank 440 to produce the line echo cancelled signal #LC. Since the line echo cancelled signal #LC contains no meaningful signal to the user during calibration mode, a mute controller 304 is enabled during calibration mode to prevent any unpleasant audible signal in the line echo cancelled signal #LC from being output to a loudspeaker 104.

Each filter unit 412 comprises an adaptive filter 414 and a subtractor 416. The adaptive filter 414 applies its filter coefficients on a subband signal X_{K} to generate a filter output #fₒᵤₜ, whereby coefficients in the adaptive filter 414 are recursively updated using training procedures to learn the echo path characteristics in that frequency subband. The subtractor 416 subtracts the filter output #fₒᵤₜ from the second subband signal Y_{K} to generate the difference signal #D_{K}.

During the calibration mode, the inbound signal #Rᵢₙ may contain a dial tone sent from the wall jack 106 when the telephone hook is released. The dial tone is an interference signal for calibration, so one or more of the filter units 412 corresponding to those frequency subbands where the dial tone frequencies reside in are being disabled during the calibration mode.

When the calibration is completed, filter units 412 are collectively converged. The telephony system 100 then switches to the normal mode. During normal mode, the calibration signal generator 302 and mute controller 304 are disabled, and an acoustic echo canceled signal #AC sent from the acoustic echo canceller 150 is passed as an outbound signal #Rₒᵤₜ to the hybrid interface circuit 130. The filter units 412 perform echo cancellation in their respective frequency subband, and a line echo cancelled signal #LC generated by the synthesis filter bank 440 is directly sent to the acoustic echo canceller 150.

The calibration signal described in the embodiment is preferably a white noise signal. The white noise signal has a flat spectrum and is ideal for rapid adaptive filter training. In digital signal processing, a common approach to generate the white noise signal is to implement a pseudo-random-number generator in the calibration signal generator 302. Since the pseudo-random-number generator is a prior art, detailed description is not provided herein.

The notch filters 306 and 308 described in the embodiment prevent interference signals from inhibiting or impeding adaptive filter training, therefore ensure rapid and reliable training of the adaptive filters.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A telephony system attachable to a wall jack, comprising:
a hybrid interface circuit, outputting an outbound signal to the wall jack and receiving an inbound signal from the wall jack, wherein the inbound signal comprises a line echo of the outbound signal caused by the hybrid interface circuit; and
a line echo canceller, coupled to the hybrid interface circuit, performing an adaptive filtering training procedure to learn the echo path characteristics, and then applying the learned echo path characteristics to cancel the line echo in the inbound signal, wherein:
during a brief period immediately after the telephony system is activated, the line echo canceller enters a calibration mode to learn the echo path characteristics; and
in the calibration mode, the line echo canceller generates a calibration signal as the outbound signal and receives the line echo from the hybrid interface circuit to learn the echo path characteristics by performing training on the adaptive filter coefficients.

2. The telephony system as claimed in claim 1, wherein the telephony system enters into a normal mode when the brief period is over, or when a digit tone is entered by the local user.

3. The telephony system as claimed in claim 1, wherein the line echo canceller comprises:
a calibration signal generator, providing the calibration signal to the hybrid interface circuit when in the calibration mode, such that the inbound signal containing the line echo of the calibration signal is used by the adaptive filter in the line echo canceller to learn the echo path characteristics;
a first notch filter, eliminating dial tone frequencies from the calibration signal to generate a first notched signal;
an adaptive filter, applies its filter coefficients on the first notched signal to generate a filter output, whereby coefficients in the adaptive filter are recursively updated using training procedures to learn the echo path characteristics;
a second notch filter, eliminating dial tone frequencies from the inbound signal to generate a second notched signal; and
a subtractor, subtracting the filter output from the second notched signal to generate the difference signal.

4. The telephony system as claimed in claim 3, wherein the line echo canceller further comprises a mute controller, enabled during the calibration mode to prevent the difference signal from being output to a loudspeaker.

5. The telephony system as claimed in claim 4, wherein when in the normal mode:
the calibration signal generator, mute controller, first notch filter and second notch filter are disabled, and a normal outbound signal is output;
the adaptive filter uses the echo path characteristics to generate a filter output from the normal outbound signal; and
the subtractor subtracts the filter output from the inbound signal to generate a difference signal, whereby the difference signal is output as a line echo cancelled signal.

6. The telephony system as claimed in claim 2, wherein the line echo canceller comprises:
a calibration signal generator, providing the calibration signal to the hybrid interface circuit when in the calibration mode, such that the inbound signal containing the line echo of the calibration signal is used by the adaptive filter in the line echo canceller to learn the echo path characteristics;
a first analysis filter bank, analyzing the outbound signal into a plurality of first frequency subband signals each corresponding to a subband;
a second analysis filter bank, analyzing the inbound signal into a plurality of second frequency subband signals each corresponding to a subband;
a plurality of filter units coupled to the first and second analysis filter banks individually performing echo cancellation on each pair of first and second subband signals;
a synthesis filter bank, synthesizing echo cancellation results output from the subband filter units to output a line echo cancelled signal; and
a mute controller, enabled during the calibration mode to prevent the line echo cancelled signal from being output to a loudspeaker.

7. The telephony system as claimed in claim 6, wherein each filter unit comprises:
an adaptive filter, applies its filter coefficients on a first subband signal to generate a filter output based on a first subband signal, whereby coefficients in the adaptive filter within the filter unit are recursively updated using training procedures to learn the echo path characteristics in the frequency subband;
a subtractor, subtracting the filter output from the second subband signal to generate the difference signal.

8. The telephony system as claimed in claim 6, wherein:
one or more of the filter units associated to dial tone frequency subbands are disabled in the calibration mode and enabled only in the normal mode.

9. The telephony system as claimed in claim 7, wherein when in the normal mode:
the calibration signal generator and mute controller are disabled, and a normal outbound signal is output;
the filter coefficients in the adaptive filter are updated according to the echo path characteristics to perform echo cancellation; and
the synthesis filter bank outputs the line echo cancelled signal to the loudspeaker.

10. The telephony system as claimed in claim 1, further comprising:
a loudspeaker, outputting a local output signal;
a microphone, receiving a local input signal, wherein the local input signal contains echo of the local output signal;
an acoustic echo canceller, coupled to the microphone and the loudspeaker, canceling the echo of the local output signal from the local input signal to generate an acoustic echo canceled signal; wherein:
the local output signal is the line echo cancelled signal output from the line echo canceller; and
the acoustic echo canceled signal is sent to the line echo canceller and output as the outbound signal.

11. The telephony system as claimed in claim 1, wherein the calibration signal is a white noise signal.

12. An echo cancellation method for a telephony system attachable to a wall jack, comprising:
during a brief period after the telephony system is activated, entering a calibration mode to learn the echo path characteristics of a line echo; and
in the calibration mode:
generating a calibration signal as an outbound signal; and
receiving a line echo corresponding to the calibration signal to learn the echo path characteristics; and
in a normal mode:
outputting a normal outbound signal to the wall jack while receiving a inbound signal from the wall jack, wherein the inbound signal contains a line echo caused by the outbound signal; and
performing filtering using the learned echo path characteristics to cancel the line echo in the inbound signal.

13. The echo cancellation method as claimed in claim 12, further comprising, entering the normal mode when the brief period is over, or when a dial tone is received.

14. The echo cancellation method as claimed in claim 12, further comprising:
when in the calibration mode:
sending the calibration signal to the wall jack, such that the inbound signal containing a line echo is used for learning the echo path characteristics;
eliminating dial tone frequencies from the calibration signal to generate a first notched signal;
applying the filter coefficients on the first notched signal to generate a filter output, whereby coefficients for the adaptive filter are recursively updated using training procedures to learn the echo path characteristics;
eliminating dial tone frequencies from the inbound signal to generate a second notched signal; and
subtracting the filter output from the second notched signal to generate the difference signal.

15. The echo cancellation method as claimed in claim 14, further comprising, when in the calibration mode, preventing the difference signal from being output to a loudspeaker 104.

16. The echo cancellation method as claimed in claim 15, further comprising:
when in the normal mode:
using the echo path characteristics to generate a filter output from the normal outbound signal; and
subtracting the filter output from the inbound signal to generate a difference signal, whereby the difference signal is output as a line echo cancelled signal.

17. The echo cancellation method as claimed in claim 13, further comprising:
when in the calibration mode:
sending the calibration signal as the outbound signal to the wall jack, such that the inbound signal containing a line echo is used for learning the echo path characteristics;
analyzing the outbound signal into a plurality of first subband signals each corresponding to a frequency subband;
analyzing the inbound signal into a plurality of second subband signals each corresponding to a frequency subband;
individually performing echo cancellation on each pair of first and second subband signals;
synthesizing echo cancellation results from the subbands to output a line echo cancelled signal; and
preventing the line echo cancelled signal from being output to a loudspeaker.

18. The echo cancellation method as claimed in claim 17, wherein echo cancellation on each pair of first and second subband signals comprises:
applying the filter coefficients on the first subband signal to generate a filter output signal, whereby the coefficients for the adaptive filter are recursively updated using training procedures to learn the echo path characteristics;
subtracting the filter output from the second subband signal to generate the difference signal.

19. The echo cancellation method as claimed in claim 17, further comprising disabling one or more frequency subbands containing associated to dial tone frequencies during the calibration mode.

20. The echo cancellation method as claimed in claim 19, further comprising:
when in the normal mode:
using the echo path characteristics to perform echo cancellation; and
outputting the line echo cancelled signal to the loudspeaker.

21. The echo cancellation method as claimed in claim 12, further comprising:
outputting a local output signal via a loudspeaker while receiving a local input signal from a microphone, wherein the local input signal contains echo of the local output signal;
cancelling the echo of the local output signal from the local input signal to generate an acoustic echo canceled signal; wherein:
the local output signal is the line echo cancelled signal; and
the acoustic echo cancelled signal is output as the outbound signal.

22. The echo cancellation method as claimed in claim 12, wherein the calibration signal is a white noise signal.
